(19) United States
(12) Patent Application Publication
(10) Pub. No.: US 2019/0266416 A1
(43) Pub. Date: Aug. 29, 2019

(54) VEHICLE IMAGE SYSTEM AND METHOD FOR POSITIONING VEHICLE USING VEHICLE IMAGE

(71) Applicant: oToBrite Electronics Inc., Hsinchu (TW)

(72) Inventors: Chen-Wei HUNG, Hsinchu (TW); Chung-Fang CHIEN, Hsinchu (TW)

(21) Appl. No.: 16/411,497

(22) Filed: May 14, 2019

Related U.S. Application Data
(63) Continuation-in-part of application No. 14/935,437, filed on Nov. 8, 2015.

(51) Int. Cl. G06K 9/00; H04N 7/18

(52) U.S. Cl. CPC G06K 9/00791; B60R 1/00; H04N 7/181

(57) ABSTRACT

A vehicle image system and a method for positioning vehicles using vehicle image are disclosed. The method comprises: capturing images from a surrounding environment of the vehicle to generate successive image data frames by at least one image capturer; receiving the successive image data frames from the at least one image capturer by a processing module having a power receiver location data describing a location of the power receiver relative to that of the vehicle; and generating an image data depicting the scene under the vehicle bottom and the portion of the scene of the surrounding environment blocked by the vehicle with the successive image data frames in real time after the vehicle moves by the processing module.

### FIELD OF THE INVENTION

The present invention relates to an image system and a method for positioning vehicles. More particularly, the present invention relates to a vehicle image system and a method for positioning vehicles using vehicle images.

### BACKGROUND OF THE INVENTION

Vehicles, such as cars, trucks, and other motor-driven vehicles, are usually provided with one or more image capturers that capture images or videos of the surrounding environment. For example, a rear-view image capturer can be mounted at the rear of an automobile and used to capture videos of the rear environment of the automobile. While the automobile is in a reverse driving mode, the captured videos can be displayed (e.g., at a center console display) to the driver or passengers. Such image systems can help assist the driver in operating the vehicle, enhancing vehicle safety. For example, displayed video image data from the rear-view image capturer can help the driver to identify obstructions that would otherwise be difficult to visually identify (e.g., through the rear windshield, rear-view mirrors, or side mirrors of the vehicle) on the path.

Vehicles are sometimes provided with additional image capturers on various positions. For example, image capturers may be mounted on the front, sides, and rear of the vehicles for capturing images from various regions of the surrounding environment. The images from the additional image capturers can be combined to obtain an around view image. The Around View Monitor (AVM) Technique thus widely applied to vehicles based on the mature image capturers thereon. A well-known application of AVM is Blind Spot Information System (BLIS), usually displayed as an eagle view over a screen. However, the bottom of the vehicle is always the unconquered blind spot on the eagle view.

On the other hand, as to applications of electric vehicles or hybrid electric vehicles, wireless charging has become a convenient and common technology. The wireless charging technology can charge vehicles without connecting to a charging cable. It significantly improves the inconvenience when charging. Before wireless charging is processed, a power receiver of the vehicle and a power transmitter must be overlapped. The power transmitter is usually placed on the ground and marks showing the location of the power transmitter are arranged around. However, it is still difficult for the driver to move the vehicle to make the power receiver overlap the power transmitter. Therefore, how to easily and accurately overlap the power receiver and the power transmitter is the subject of interest to those skilled in the art.

It is desired that a vehicle image system can be available to make charging vehicles easily. Especially, the vehicle image system is based on an improved AVM and has functions of Artificial Intelligence (AI) identification.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

According to an aspect of the present invention, a vehicle image system is disclosed. The vehicle image system is installed in a vehicle which has a power receiver and comprises: at least one image capturer, mounted to the vehicle, for capturing images from a surrounding environment of the vehicle to generate successive image data frames, wherein a view of the at least one image capturer for capturing images has a scene under the vehicle bottom or a portion of a scene of the surrounding environment blocked by the vehicle so that any one of the successive image data frames lacks the scene under the vehicle bottom or the portion of the scene of the surrounding environment; and a processing module, connected with the at least one image capturer, having a power receiver location data describing a location of the power receiver relative to that of the vehicle, for receiving the successive image data frames from the at least one image capturer, and generating an image data depicting the scene under the vehicle bottom and the portion of the scene of the surrounding environment blocked by the vehicle with the successive image data frames in real time after the vehicle moves.

Another aspect of the present invention is to provide a method for positioning vehicles using vehicle images, suitable for a vehicle installed with at least one image capturer and a power receiver. The method comprises: capturing images from a surrounding environment of the vehicle to generate successive image data frames by at least one image capturer, wherein a view of the at least one image capturer for capturing images has a scene under the vehicle bottom and a portion of a scene of the surrounding environment blocked by the vehicle so that any one of the successive image data frames lacks the scene under the vehicle bottom or the portion of the scene of the surrounding environment; receiving the successive image data frames from the at least one image capturer by a processing module having a power receiver location data describing a location of the power receiver relative to that of the vehicle; and generating an image data depicting the scene under the vehicle bottom and the portion of the scene of the surrounding environment blocked by the vehicle with the successive image data frames in real time after the vehicle moves by the processing module.

The vehicle image system provided by the present invention generates an image data depicting the scene under the vehicle bottom and the portion of the scene of the surrounding environment blocked by the vehicle when the vehicle operates by successive image data frames from the at least one image capturer. It can easily and accurately overlap the power receiver with the power transmitter.

### BRIEF DESCRIPTION OF THE DRAWINGS

FIG. 1 is an illustrative diagram of displayed obstruction-compensated images in accordance with an embodiment of the present invention.

FIG. 2 is a diagram illustrating coordinate transformation that may be used to combine images from multiple cameras having different perspectives.

FIG. 3 is an illustrative diagram showing how camera-obstructed regions of a surrounding environment may be updated with time-delayed information based on steering angle and vehicle speed information in accordance with an embodiment of the present invention.

FIG. 4 is an illustrative diagram showing how an image buffer may be updated with current and time-delayed camera image data in displaying an obstruction-compensated image of vehicle surroundings in accordance with an embodiment of the present invention.

FIG. 5 is a flowchart of illustrative steps that may be performed to display an obstruction-compensated image in accordance with an embodiment of the present invention.

FIG. 6 is an illustrative diagram of an automotive vehicle having multiple cameras that capture image data that may be combined to generate obstruction-compensated video image data in accordance with an embodiment of the invention.

FIG. 7 is a block diagram of an illustrative imaging system that may be used to process camera image data to generate obstruction-compensated video image data in accordance with an embodiment of the invention.

FIG. 8 is a diagram illustrating how multiple buffers may be updated in succession to store current and time-delayed camera image data in displaying an obstruction-compensated image of vehicle surroundings in accordance with an embodiment of the present invention.

FIG. 9 is a schematic diagram of an embodiment of a vehicle image system according to the present invention.

FIG. 10 a block diagram of the vehicle image system and hardware it connects to.

FIG. 11 shows how the moving path is generated.

FIG. 12 shows two comparative graphs that are shown on a display module.

FIG. 13 shows 4 wheels by dashed rectangles on the display module.

FIG. 14 is a flowchart of a method for positioning vehicles using vehicle images of an embodiment in the present invention.

FIG. 15 is a flowchart of another method for positioning vehicles using vehicle images of an embodiment in the present invention.

FIG. 16 is a flowchart of another method for positioning vehicles using vehicle images of an embodiment in the present invention.

FIG. 17 is a flowchart of additional steps for preparing and displaying preparatory information.

FIG. 18 is a flowchart of a method for positioning vehicles in a driver-mode of an embodiment in the present invention.

FIG. 19 is a flowchart of another method for positioning vehicles in a driver-mode of an embodiment in the present invention.

FIG. 20 is a flowchart of another method for positioning vehicles in a driver-mode of an embodiment in the present invention.

### DETAILED DESCRIPTION OF THE PREFERRED EMBODIMENTS

The present invention will now be described more specifically with reference to the following embodiments.

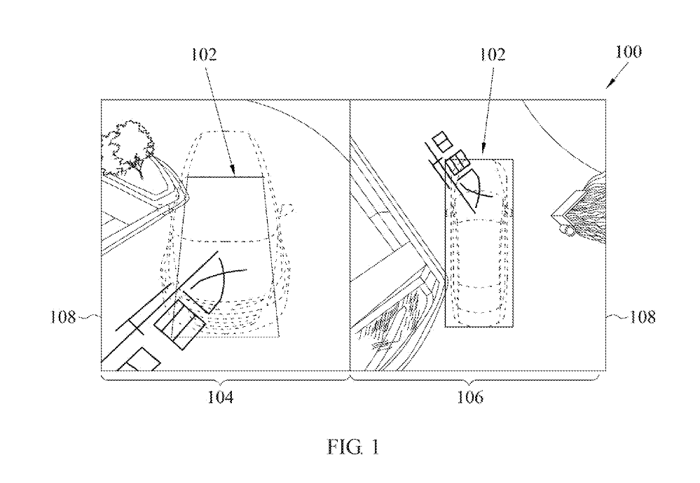

FIG. 1 shows a diagram of an obstruction-compensated image 100 that may be created using time-delayed image data. In the example of FIG. 1, image 100 may be generated from image data such as video image data from multiple cameras mounted to a vehicle at various locations. For example, cameras may be mounted to the front, rear, and/or sides of the vehicle. Image 100 may include portions 104 and 106, each portraying a different perspective of the surrounding environment. Image portion 104 may reflect a front perspective view of the vehicle and its surroundings, whereas image portion 106 may portray a top-down view (sometimes referred to as a bird eye view, because image portion 106 appears to have been captured from a vantage point above the vehicle).

Image portions 104 and 106 may include regions 102 that correspond to portions of the surrounding environment that are obstructed from camera view. In particular, the vehicle may include a frame or chassis that provides structural support for the various components and parts of the vehicle (e.g., support for the motor, wheels, seats, etc.). The cameras may be mounted directly or indirectly to the vehicle chassis, and the chassis itself may obstruct parts of the vehicle surroundings from the cameras. Regions 102 correspond to portions underneath the vehicle chassis that are obstructed from camera view, whereas regions 108 correspond to unobstructed surroundings. In the example of FIG. 1, the vehicle is moving on a road, and regions 102 display portions of the road that are currently underneath the vehicle chassis and would otherwise be obstructed from view of cameras that are mounted to the front, sides, and/or rear of the vehicle. Image data in regions 102 may be generated using time-delayed image data received from the vehicle cameras, whereas image data in regions 108 may be generated using current image data from the vehicle cameras (e.g., because the corresponding portions of the surrounding environment are not obstructed from view of the cameras by the vehicle chassis).

Successive images 100 (e.g., images generated at successive times) may form a stream of images, sometimes referred to as a video stream or video data. The example of FIG. 1 in which image 100 is composed of regions 104 and 106 is merely illustrative. Image 100 may be composed of one or more regions each having a front perspective view (e.g., region 104), a bird eye view (e.g., region 106), or any desired view of the vehicle's surrounding environment that is generated from image data from the cameras.

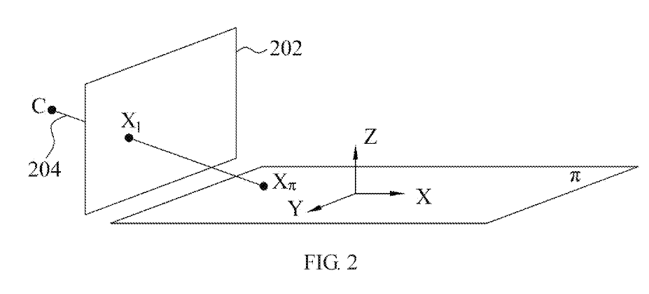

Cameras that are mounted to a vehicle each have a different view of the surrounding environment. It may be desirable to transform the image data from each camera to a common perspective. For example, image data from multiple cameras may each be transformed to the front perspective view of image region 104 and/or the bird eye perspective view of image region 106. FIG. 2 shows how image data from a given camera in a first plane 202 may be transformed to a desired coordinate plane n defined by the orthogonal X, Y, and Z axis. As an example, coordinate plane n may be a ground plane that extends between the wheels of the automotive vehicle. The transformation of image data from one coordinate plane (e.g., the plane as captured by the camera) to another coordinate plane may sometimes be referred to as coordinate transformation, or projective transformation.

As shown in FIG. 2, images captured by the camera may include image data (e.g., a pixel) at coordinates such as point x1 in camera plane 202 along vector 204. Vector 204 extends between point x1 in plane 202 and a corresponding point xn in target plane n. For example, vector 204 may be based on the angle at which the camera is mounted on the car and angled towards the ground, because vector 204 is drawn between a point on plane 202 of the camera and plane n of the ground plane.

Image data captured by the camera in coordinate plane 202 may be transformed (e.g., projected) onto coordinate plane n according to a matrix formula xπ=H*x1. Matrix H can be calculated and determined via calibration processes for the camera. For example, the camera may be mounted to a desired location on a vehicle, and calibration images may be taken to produce images of a known environment. In this scenario, multiple pairs of corresponding points in planes 202 and n may be known (e.g., x1 and xn may constitute a pair), and H can be calculated based on the known points.

As an example, point x1 may be defined as x1=(xᵢ,yᵢ,wᵢ) by the coordinate system of plane 202, whereas point x π may be defined as x π =(xᵢ′,yᵢ′,wᵢ′) by the coordinate system of plane π. In this scenario, matrix H may be defined as shown in equation 1, the relationship between x1 and xπ may be defined as shown in equation 2.

$$\begin{matrix}H = [ \begin{matrix}{h}_{11} & {h}_{12} & {h}_{13} \\ {h}_{21} & {h}_{22} & {h}_{23} \\ {h}_{31} & {h}_{32} & 1\end{matrix} ] & Equation 1 \\ [ \begin{matrix}{h}_{11} & {h}_{12} & {h}_{13} \\ {h}_{21} & {h}_{22} & {h}_{23} \\ {h}_{31} & {h}_{32} & 1\end{matrix} ] [ \begin{matrix}{x}_{i} \\ {y}_{i} \\ {ω}_{i}\end{matrix} ] = [ \begin{matrix}{x}_{i}^{′} \\ {y}_{i}^{′} \\ {ω}_{i}^{′}\end{matrix} ] & Equation 2\end{matrix}$$

Each camera that is mounted to the vehicle may be calibrated to calculate a respective matrix H that transforms coordinates at the camera's plane to a desired coordinate plane. For example, in a scenario in which cameras are mounted to the front, rear, and sides of a vehicle, each of the cameras may be calibrated to determined respective matrices that transform image data captured by that camera to projected image data on a shared, common image plane (e.g., a ground image plane from a birds eye perspective such as shown in image region 106 of FIG. 1, or the common plane of a front perspective view as shown in image region 104 of FIG. 1). During display operations, the image data from each of the cameras may be transformed using the calculated matrices and combined to display the surrounding environment from the desired perspective.

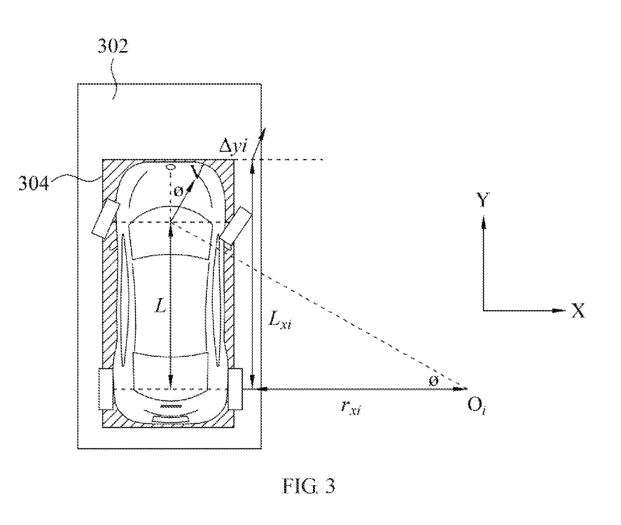

Time-delayed image data may be identified based on vehicle data. The vehicle data may be provided by control and/or monitoring systems (e.g., over a communications path such as a controller area network bus). FIG. 3 is an illustrative diagram showing how a future vehicle position may be calculated based on current vehicle data including steering angle cp (e.g., average front wheel angle), vehicle speed V, and wheelbase length L (i.e., length between front and rear wheels). The future vehicle position may be used to identify which portion of currently captured image data should be used to approximate blocked regions of the surrounding environment at a future time.

The angular speed of the vehicle may be calculated based on the current vehicle speed V, wheelbase length L, and steering angle φ (e.g., as described in equation 3).

$$ω = \frac{V}{L} csc ( φ ) \qquad Equation 3$$

For each location, a corresponding future position may be calculated based on projected movement Δyi. Projected movement Δyi may be calculated based on that location's X-axis distance rxi and Y-axis distance Lxi from the center of the vehicle's turning radius and the vehicle angular speed (e.g., according to equation 4). For each location within camera-obstructed region 304, the projected movement can be used to determine whether the projected future location is within the currently viewable region of the vehicle's surroundings (e.g., region 302). If the projected location is located within the currently viewable region, then current image data for the projected location can be displayed to approximate the projected region of the future environment after the vehicle moves and the projected region of the environment becomes obstructed. Equation 4:

Δyᵢ=\sqrt{Lₓᵢ²+rₓᵢ²}×ω

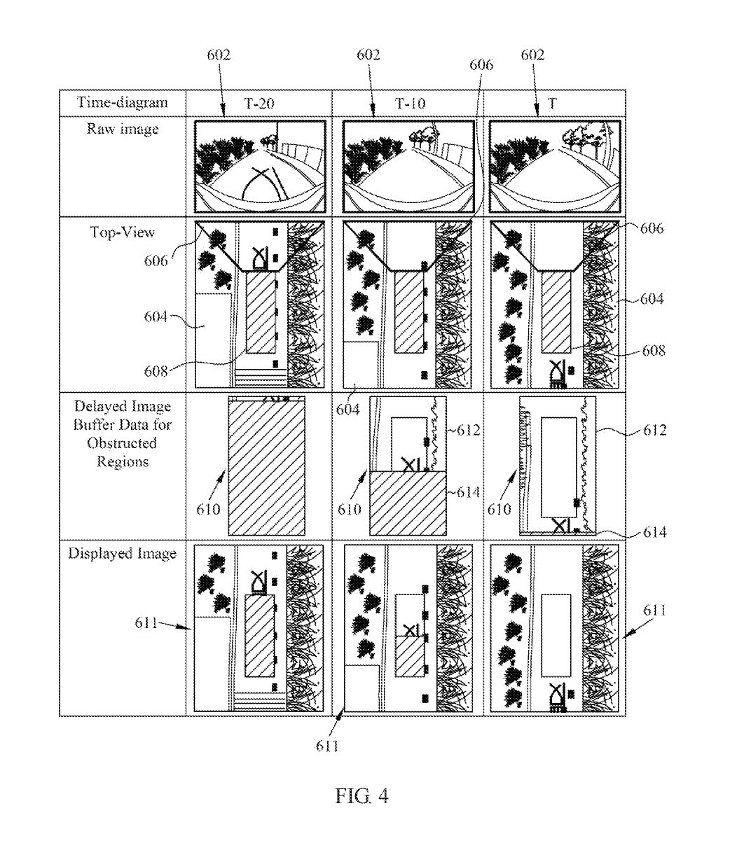

FIG. 4 is a diagram showing how raw camera image data may be coordinate-transformed and combined with time-delayed image data to display vehicle surroundings.

At initial time T-20, multiple cameras may capture and provide raw image data of the vehicle's surroundings. Raw image data frame 602 may be captured, for example, by a first camera mounted to the front of the vehicle, whereas additional raw image data frames may be captured by cameras mounted to the left side, right side, and rear of the vehicle (omitted from FIG. 4 for clarity). Each raw image data frame includes image pixels arranged in horizontal rows and vertical columns.

The imaging system may process the raw image data frame from each camera to coordinate-transform the image data to a common perspective. In the example of FIG. 4, image data frames from each of the front, left, right, and rear cameras may be coordinate-transformed from the perspective of that camera to a common birds-eye, top-view perspective (e.g., as described in connection with FIG. 2). The coordinate-transformed image data from the cameras may be combined to form a current live-view image 604 of the vehicle's surroundings. For example, region 606 may correspond to the surrounding area that is viewed and captured in raw image 602 from the front camera, whereas other regions of combined image 604 may be captured by other cameras. Top-view image 604 may be stored in an image buffer. If desired, additional image processing may be performed such as lens distortion processing that corrects for image distortion from focusing lenses of the cameras.

In some scenarios, the perspectives of cameras mounted to the vehicle may overlap (e.g., the views of front and side cameras may overlap at the border of region 606). If desired, the imaging system may combine overlapping image data from different cameras, which may help to improve the image quality at the overlapping regions.

As shown in FIG. 4, region 608 may reflect an obstructed portion of the surrounding environment. Region 608 may, for example, correspond to a vehicle chassis or other parts of the vehicle that obstruct the underlying road from the view of the cameras. The obstructed region(s) may be determined based on the mounting position and the vehicle's physical attributes (e.g., the size and shape of the vehicle frame). The imaging system may maintain a portion of the image buffer or a separate image buffer corresponding to the obstructed region(s) using delayed image data. At initial time T-20, no image data may have yet been saved, and image buffer portion 610 may be empty or filled with initialization data. The imaging system may display the combination of current camera image data and the delayed image buffer data as a composite image 611.

At subsequent time T-10, the vehicle may have moved relative to time T-20. The cameras may capture a different image due to its new environmental location (e.g., raw image 602 at time T-10 may be different than raw image 602 at time T-20), and thus top-view image 604 reflects that the vehicle has moved since time T-20. Based on vehicle data such as vehicle speed, steering angle, and wheelbase length, the image processing system may determine that part of viewable area 606 at time T-20 is now obstructed by the vehicle chassis (e.g., due to movement of the vehicle between times T-20 and T-10). The image processing system may transfer the identified image data from the previously viewable area 606 to corresponding region 612 of image buffer 610. Displayed image 611 includes the transferred image data in region 612 as a time-delayed approximation of part of the vehicle's surroundings that are now obstructed from camera view.

At time T-10, portion 614 of the image buffer remains empty or filled with initialization data, because the vehicle has not moved sufficiently to allow approximation via portions of previously-viewable surroundings. At subsequent time T, the vehicle may have moved sufficiently such that substantially all of the obstructed surroundings can be approximated with time-delayed image data captured from previously-viewable surroundings.

In the example of FIG. 4, the vehicle moves forward between times T-20 and T and the delayed image buffer is updated with images captured by a front vehicle camera. This example is merely illustrative. The vehicle may move in any desired direction, and the time-delayed image buffer may be updated with image data captured by any appropriate camera that is mounted to the vehicle (e.g., front, rear, or side cameras). In general, all or part of the combined image from the cameras (e.g., top-view image 604) at any given time may be stored and displayed as time-delayed approximations of future vehicle surroundings.

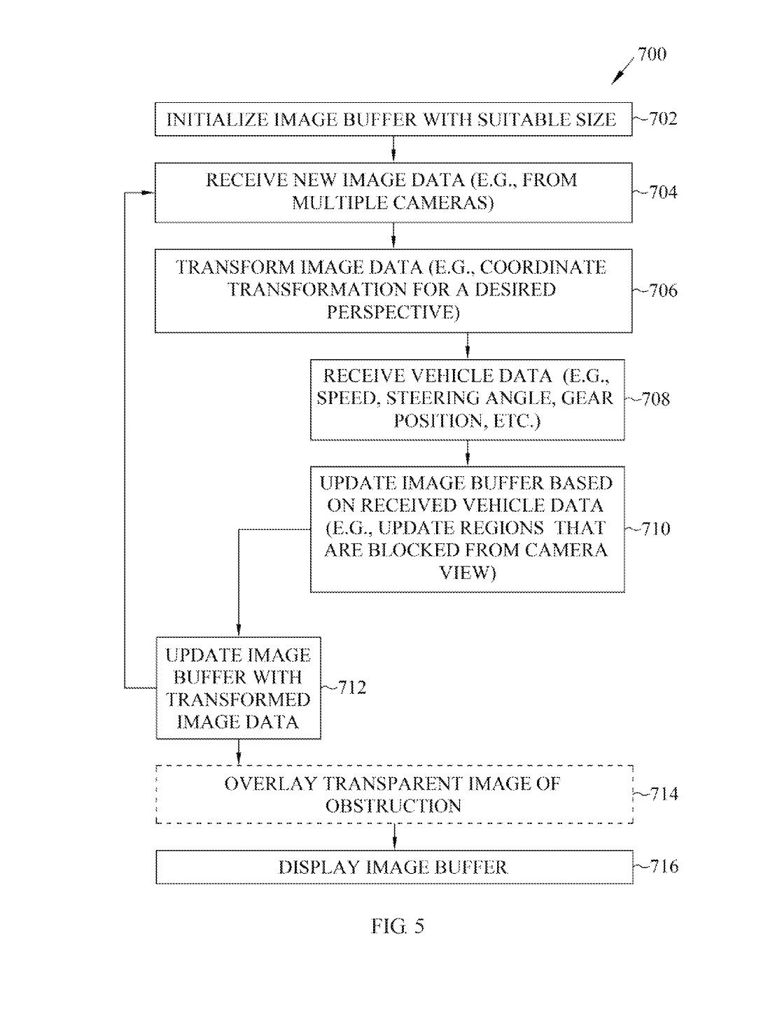

FIG. 5 is a flow chart of illustrative steps that may be performed by an image processing system in storing and displaying time-delayed image data in approximating current vehicle surroundings.

During step 702, the image processing system may initialize an image buffer with a suitable size for storing image data from vehicle cameras. For example, the system may determine the image buffer size based on a maximum vehicle speed that is desired or supported (e.g., a larger image buffer size for higher maximum vehicle speed, and a smaller size for a lower maximum vehicle speed).

During step 704, the image processing system may receive new image data. The image data may be received from one or more vehicle cameras, and may reflect the current vehicle environment.

During step 706, the image processing system may transform the image data from the camera's perspectives to a desired common perspective. For example, the coordinate transformation of FIG. 2 may be performed in projecting image data received from a particular camera to a desired coordinate plane for a desired view of the vehicle and its surroundings (e.g., a perspective view, a top-down view, or any other desired view).

During step 708, the image processing system may receive vehicle data such as vehicle speed, steering angle, gear position, and other vehicle data that can be used in identifying movement of the vehicle and corresponding shifts in image data.

During subsequent step 710, the image processing system may update the image buffer based on the received image data. For example, the image processing system may have allocated part of the image buffer such as region 608 of FIG. 4 to represent an obstructed region of the surrounding environment. In this scenario, the image processing system may process the vehicle data to determine which portions of previously captured image data (e.g., image data captured by cameras and received prior to the current iteration of step 704) should be transferred or copied to region 608. For example, the image processing system may process vehicle speed, steering angle, and wheelbase length to identify which image data from region 606 of FIG. 4 should be transferred to each portion of region 608. As another example, the image processing system may process gear information such as whether the vehicle is in a forward gear mode or a reverse gear mode to determine whether to transfer from image data received from a front camera (e.g., in region 606) or from a rear camera.

During subsequent step 712, the image processing system may update the image buffer with the new image data received from the cameras during step 704 and transformed during step 706. The transformed image data may be stored in regions of the image buffer that represent viewable portions of the surrounding environment (e.g., image buffer portion 604 of FIG. 4).

If desired, a transparent image of the obstruction may be overlaid with the image buffer during optional step 714. For example, as shown in FIG. 1, a transparent image of a vehicle may be overlaid with the portion of the image buffer that approximates the road underlying the vehicle (e.g., using time-delayed image data).

By combining currently captured image data during step 712 and previously captured (e.g., time-delayed) image data during step 710, the image processing system may produce and maintain a composite image in the image buffer that portrays the vehicle surroundings despite obstructions such as a vehicle chassis that block portions of the surrounding environment from view of the camera at any given time. The process may be repeated to create a video stream that displays the surrounding environment as if there were no obstructions to camera view.

During subsequent step 716, the image processing system may retrieve the composite image data from the image buffer and display the composite image. If desired, the composite image may be displayed with a transparent overlay of the obstruction, which may help to inform users of the obstruction's existence and that the information displayed within the overlay of the obstruction is time-delayed.

The example of FIG. 5 in which vehicle data is received during step 708 is merely illustrative. The operations of step 708 may be performed during any suitable time (e.g., before or after steps 704, 706, or 712).

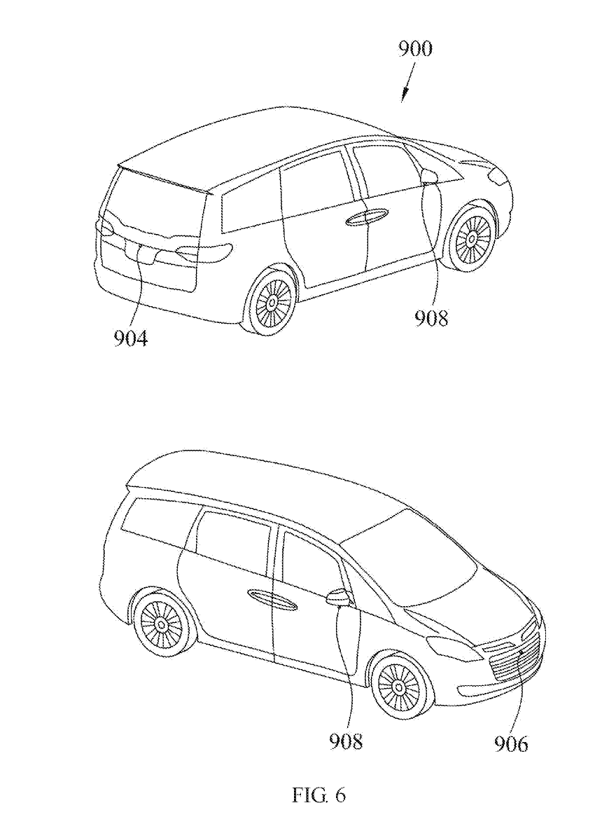

FIG. 6 shows illustrative views of a vehicle 900 and cameras that are mounted to the vehicle (e.g., to the vehicle frame or to other vehicle parts). As shown in FIG. 6, front camera 906 may be mounted to a front side (e.g., front surface) of the vehicle, whereas rear camera 904 may be mounted to an opposing rear side of the vehicle. Front camera 906 may be directed towards and capture images of the environment within the proximity of the front of vehicle 900, whereas rear camera 904 may be directed towards and capture images of the environment near the rear of the vehicle. Right camera 908 may be mounted to a right side of the vehicle (e.g., to a side-view mirror on the right side) and capture images of the environment on the right side of the vehicle. Similarly, a left camera may be mounted to a left side of the vehicle (omitted).

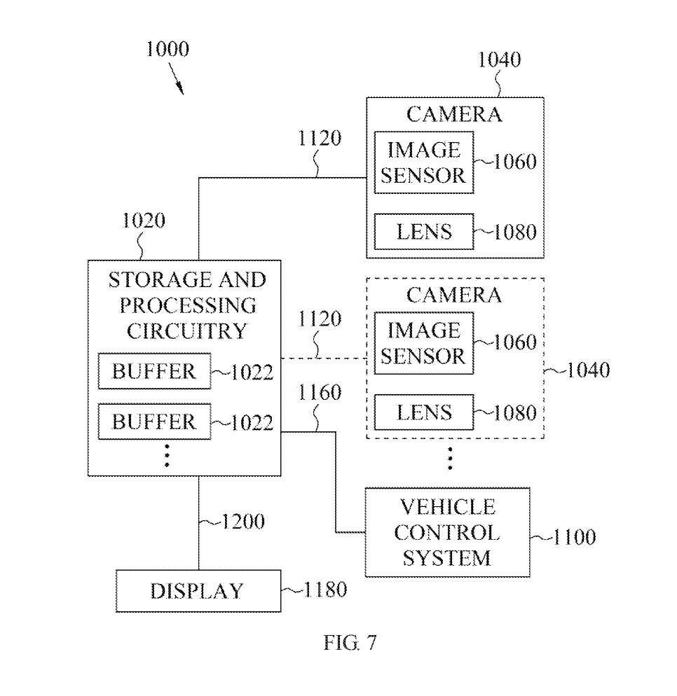

FIG. 7 shows an illustrative image processing system 1000 that includes storage and processing circuitry 1020 and one or more cameras 1040 (e.g., camera 1040 and one or more optional cameras 1040′). Each camera 1040 may include an image sensor 1060 that captures images and/or video. Image sensor 1060 may, for example, include photodiodes or other light-sensitive elements. Each camera 1040 may include a lens 1080 that receives and focuses light from the environment on a respective image sensor 1060. Image sensor 1060 may, for example, include horizontal and vertical rows of pixels that each captures light to produce image data. The image data from the pixels may be combined to form image data frames, and successive image data frames may form video data. The image data may be transferred to storage and processing circuitry 1020 over communications paths 1120 (e.g., cables or wires).

Storage and processing circuitry 1020 may include processing circuitry such as one or more general purpose processors, specialized processors such as digital signal processors (DSPs), or other digital processing circuitry. The processing circuitry may receive and process the image data received from cameras 1040. For example, the processing circuitry may perform the steps of FIG. 5 in generating composite obstruction-compensated images from current and time-delayed image data. The storage circuitry may be used in storing the image. For example, the processing circuitry may maintain one or more image buffers 1022 to store captured and processed image data. The processing circuitry may communicate with vehicle control system 1100 over communications path 1160 (e.g., one or more cables over which a communications bus such as a controller area network bus is implemented). The processing circuitry may request and receive vehicle data such as vehicle speed, steering angle, and other vehicle data from the vehicle control system over path 1160. Image data such as obstruction-compensated video may be provided to display 1180 for displaying (e.g., to a user such as a driver or passenger of the vehicle). For example, circuitry 1020 may include one or more display buffers (not shown) that provide display 1180 with display data. In this scenario, circuitry 1020 may transfer image data to be displayed from portions of image buffers 1022 to the display buffers during display operations.

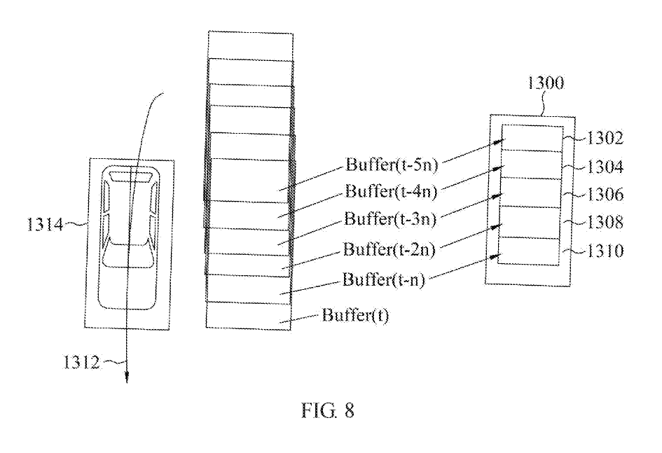

FIG. 8 is a diagram illustrating how multiple buffers may be updated in succession to store current and time-delayed camera image data in displaying an obstruction-compensated image of vehicle surroundings in accordance with an embodiment of the present invention. In the example of FIG. 8, image buffers are used to store successively captured image data at times t, t−n, t−2n, t−3n, t−4n, and t−5n (e.g., where n represents a unit of time that may be determined based on vehicle speeds to be supported by the imaging system).

In displaying an obstruction-compensated image of the vehicle surroundings, image data may be retrieved from the image buffers and combined, which may help to improve image quality by reducing blurriness. The number of buffers used may be determined based on vehicle speed (e.g., more buffers may be used for faster speeds, whereas fewer buffers may be used for slower speeds). In the example of FIG. 8, five buffers are used.

As the vehicle moves along a path 1312, the image buffers store successively captured images (e.g., combined and coordinate-transformed images from image sensors on the vehicle). At time t for currently vehicle location 1314, the obstructed portions of the current vehicle surroundings may be reconstructed by combining portions of images captured at time t−5n, t−4n, t−3n, t−2n, and t−n. The image data for obstructed vehicle surroundings may be transferred from portions of the multiple image buffers to corresponding portions of display buffer 1300 during display operations. Image data from buffer (t−5n) may be transferred to display buffer portion 1302, image data from buffer (t−4n) may be transferred to display buffer portion 1304, etc. The resulting combined image reconstructs and approximates the currently obstructed vehicle surroundings using time-delayed information previously stored at successive times in multiple image buffers.

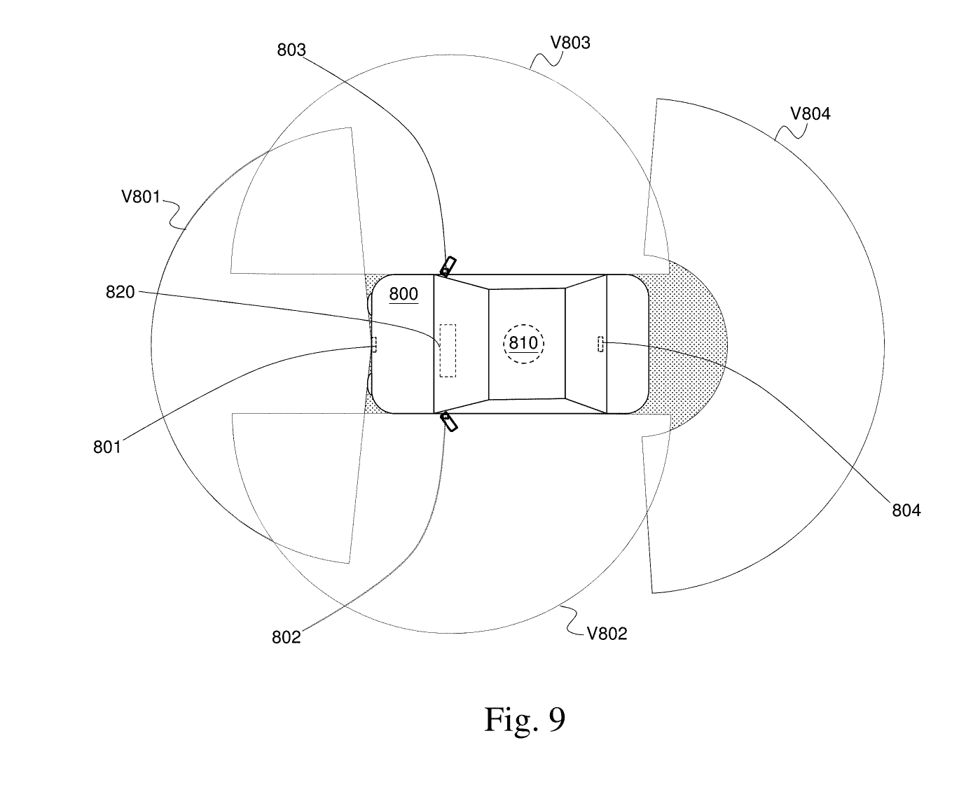

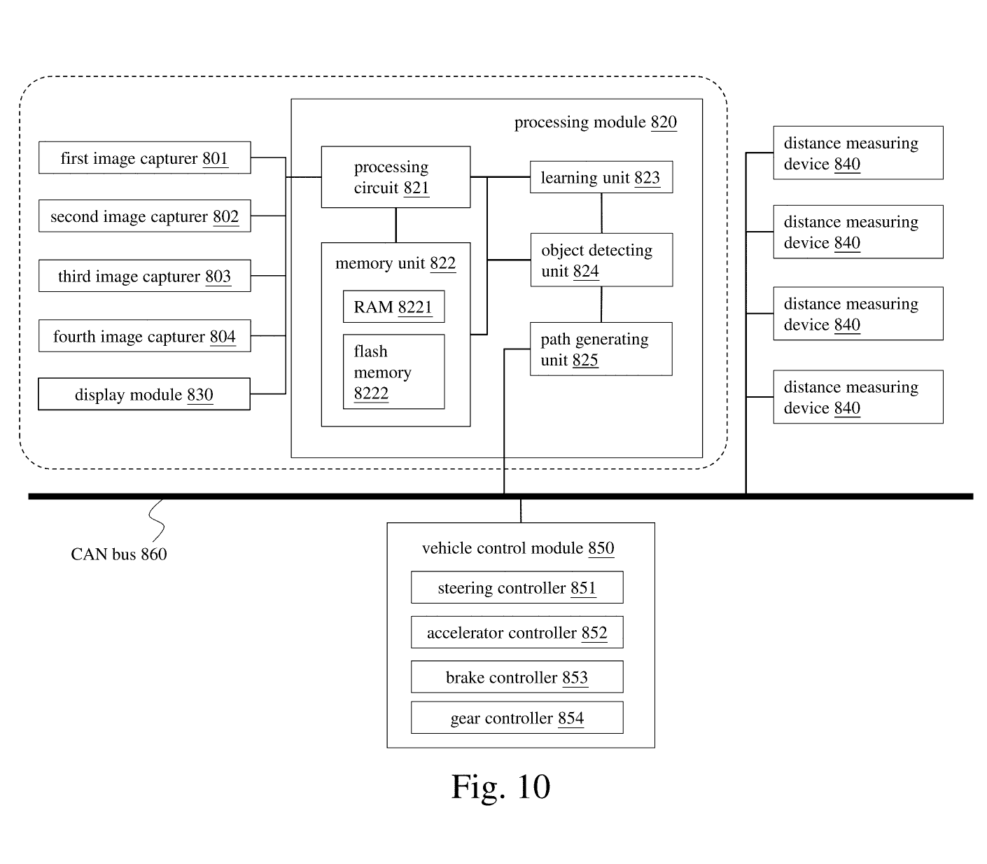

Please refer to FIG. 9. It is a schematic diagram of an embodiment of a vehicle image system according to the present invention. The vehicle image system is installed in a vehicle 800. The vehicle 800 is an electric automobile and needs to be charged in a power station. It has a power receiver 810 for that task. According to the present invention, the vehicle image system should include at least one image capturer mounted to the vehicle 800, a processing module 820 and a display module 830 (shown in FIG. 10). In this embodiment, four image capturers are used for illustration. There are a first image capturer 801, a second image capturer 802, a third image capturer 803 and a fourth image capturer 804. According to the present invention, the number of the image capturers is not limited to 4. At least one image capturer is enough. The first image capturer 801 is mounted in front of the vehicle 800, the second image capturer 802 is mounted on a left rear mirror, the third image capturer 803 is mounted on a right rear mirror and the fourth image capturer 804 is mounted near a back seat with a camera lens facing a back window. In other embodiments, the first image capturer 801 may be mounted on a rear mirror of the vehicle 800, the second image capturer 802 may be mounted on a left decorative side bar, the third image capturer 803 may be mounted on a right decorative side bar and the fourth image capturer 804 may be mounted on a bumper. The present invention doesn't restrict locations of the image capturers as long as the image capturers can fetch required data. The image capturers can capture images from a surrounding environment of the vehicle 800 to generate successive image data frames. As shown in FIG. 9, the first image capturer 801 has a view V801. The second image capturer 802 has a view V802. The third image capturer 803 has a view V803. The fourth image capturer 804 has a view V804. It should be emphasized that any area enclosed representing a specific view is just explanatory and doesn't constrain the farthest range that one image capturer is able to reach. According to the present invention, the image capturer may be, but not limit to, camera, image sensing unit with lens or optical diode. Since there is an overlap between views of adjacent image capturers, by conventional techniques, such as reducing distortion, converting viewing, stitching images, and optimizing images, an around view image can be available. It is a sort of image data frame. As operating time increases, more and more image data frames can be generated. In other embodiments, only one image capturer may be used. Thus, the capture images are from a single view. The successive image data frames are no longer of around view images. They are another sort of image data frames.

In this embodiment, the image capturers are all equipped with 180-degree wide angle lens. Ideally, they can be equipped with fisheye lens. However, due to neighboring objects, a portion of their view might be blocked. For example, the view of the first image capturer 801 is blocked by two headlights and the view V801 has an effective range less than 180 degrees. The view of the fourth image capturer 804 is blocked by the frames of the vehicle 800 and the V804 lacks a portion with an effective range less than 180 degrees. Views of the rest two image capturers 803 and 804 are not blocked by any portion of the vehicle 800 so that views V802 and V803 conform to original design. Dotted areas are used to indicate where the blocked zones are. In addition, in the around view image, the place under the vehicle bottom can not be seen by any image capturer because of the vehicle 800. Therefore, in summary, a view of each image capturer for capturing images has a scene under the vehicle bottom or a portion of a scene of the surrounding environment blocked by the vehicle 800 so that any one of the successive image data frames lacks the scene under the vehicle bottom or the portion of the scene of the surrounding environment.

The processing module 820 is connected with the four image capturers. It is a part of the vehicle computer and has kept a power receiver location data. The power receiver location data describes a location of the power receiver 810 relative to a location of the vehicle 800. In this embodiment, the power receiver 810 is installed near the chassis of the vehicle 800. The power receiver location data may, for example, include distance and direction of a geometric center of the power receiver 810 to that of the vehicle 800, or coordinates of some anchor points on the power receiver 810 and the vehicle 800 based on a relative coordinate system. No matter what the format of the power receiver location data is, it can be used to locate the power receiver 810 if the location of the vehicle 800 is known. The processing module 820 is capable of receiving the successive image data frames from the image capturers. It can also generate an image data depicting the scene under the vehicle bottom and the portion of the scene of the surrounding environment blocked by the vehicle 800 with the successive image data frames in real time after the vehicle 800 moves. Details of the principle for generating the image data is the same as what has been disclosed above. It is not repeated again.

In addition, the processing module 820 can further identify whether an appearance image of a portion of a power transmitter exposed to the ground or an indicator image in the environment exists in the successive image data frames. The power transmitter may be in a form of a charging plate placed on the ground or partially buried in the ground with a charging pile exposed. The processing module 820 knows the portion of the power transmitter which can be seen above the ground and use it to find the image in the successive image data frames. If the power transmitter is fixed under the ground and charge the vehicle 800 over air, there will be some marks on the ground or on adjacent fixtures showing the driver how to move the vehicle 800 to an aligned location to charge. The “marks” are the indicator image that is also known by the processing module 820 to identify out of the successive image data frames. Thus, the processing module 820 can determine a location of the appearance image or the indicator image relative to the vehicle 800 after the appearance image or the indicator image is identified. Once the relative location is determined, a power transmitter location data regarding the power transmitter can be labeled in the successive image data frames. The power transmitter location data may be a description about the location (in a relative coordinate system) and labeled in metadata of the successive image data frames. In practice, the power transmitter location data may be the pixels which form the appearance image of the portion of the power transmitter.

A detailed illustration of the processing module 820 and interactions with other modules and devices on the vehicle 800 is given in FIG. 10. It is a block diagram of the vehicle image system and devices it connects to. The vehicle image system is marked by a dashed frame. The processing module 820 includes a processing circuit 821, a memory unit 822, a learning unit 823, an object detecting unit 824 and a path generating unit 825. The processing circuit 821 is the central controlling hardware dealing with some important processing tasks that the vehicle image system provides. For example, the processing circuit 821 operates to process the image data frames and generate the image data. It may include a (Central Processing Unit) CPU with a number of auxiliary passive and active components assembled on a Printed Circuit Board (PCB) (not shown). In some embodiments, the CPU may be replaced by an Application Specific Integrated Circuit (ASIC). The processing circuit 821 connects to the image capturers. A connection between the processing circuit 821 and the image capturers may be wired (e.g. by cables) or wireless (e.g. via Bluetooth).

In order to enable temporary buffer and long-time storage, the memory unit 822 provides related memory functions. In general, the memory unit 822 may be equipped with a Random Access Memory (RAM) 8221 for temporary buffer and a flash memory 8222 for long-time storage. In some cases, a hard disk can be an alternative of the flash memory 8222. Any program or data is stored in the flash memory 8222 before it is called by the processing circuit 821. The RAM 8221 temporarily keeps the codes or data that the processing circuit 821 runs before they are further released. An importance of the memory unit 822 in the present invention is storing the successive image data frames and the image data.

The learning unit 823 is connected to the processing circuit 821 and the memory unit 822. It can be operated to learn what the appearance image or the indicator image. For different charging stations, different appearance images and/or indicator images may be used to guide vehicles. Unless the appearance images and/or indicator images were stored in the memory unit 822 during the time that the vehicle 800 was assembled for sale, the vehicle 800 will never know the appearance images and/or indicator images. Thus, the learning unit 823 helps the vehicle 800 know new appearance images or indicator images. There are two learning functions: self-learning and cloud-learning. For the self-learning, the learning unit 823 learns from the image data and the image data frames to obtain the appearance image of the portion of the power transmitter exposed to the ground or the indicator image in the environment, and obtain a location of the power transmitter when the power receiver 810 operates or a location chosen from the image data frames or the image data by a driver of the vehicle 800. There are various learning algorithms and related open source codes for achieving the learning purposes. Use of the algorithms, open source codes or even newly developed codes is not limited by the present invention. Learning outcomes can be recorded by the learning unit 823 as a first package and store the first package in the memory unit 822. The cloud-learning is receiving a second package externally (e.g. a cloud server) and fetching an appearance image or an indicator image in the second package. The second package may be wiredly (e.g. by a RJ45 cable linked to an Ethernet interface) or wirelessly (e.g. via Bluetooth or wi-fi to an access point of a network) received. Even, the second package can be stored and transferred to the learning unit 823 by a physical device, such as a USB storage or a hard disc. Data structures of the first package and the second package are the same. However, a self-learning process was done by the cloud server rather than the vehicle 800 itself and the second package was created thereby. The self-learning process might also be done in another vehicle and the second package was uploaded to the cloud server after it was created. By this way, resources of the learning unit 823 and the processing circuit 821 can be saved. Similarly, the first package can also be uploaded to the cloud server to share what the learning unit 823 has learned to other vehicles. It should be emphasized that for any learning unit installed in the vehicles using the vehicle image system, it may apply only one of the learning functions. Both learning functions can be designed to one learning unit 823 as well. In this embodiment, the learning unit 823 is a portion of hardware in the processing module 820. In other embodiment, the learning unit 823 may not be in the form of hardware but software operated in the processing module 820.

The object detecting unit 824 is connected to the processing circuit 821 and the learning unit 823. It can determine a location of the appearance image or the indicator image in the successive image data frames according to the appearance image or the indicator image, default or from the first package or the second package. The location, for example, may be 5.2 m and 271 degrees from the moving direction. It can be provided to the path generating unit 825 for further calculation.

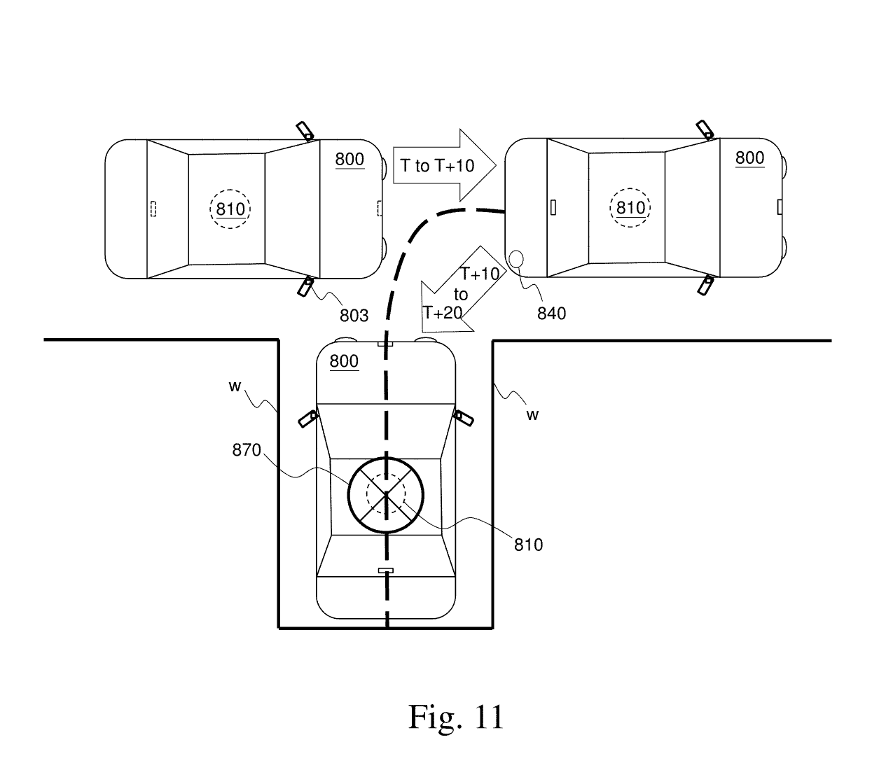

The path generating unit 825 is connected to object detecting unit 824. The path generating unit 825 connects to a number of distance measuring devices 840 mounted on the vehicle 800 and a vehicle control module 850 via the CAN bus 860. The distance measuring devices 840, e.g. ultrasonic sensors, radars or LiDAR, are fixed around the vehicle 800 to detect objects nearby. Location data of the objects are used to make sure where the detect objects are and also sent to the path generating unit 825 for further use. The vehicle control module 850 is the electrical hardware which controls motion of the vehicle 800. The vehicle control module 850 may include a steering controller 851 which controls directions of wheels according to a steering wheel; an accelerator controller 852 which controls operation of a motor based on the accelerator; a brake controller 853 slows down the speed of the vehicle 800 when a brake is pressed; and a gear controller 854 programmed to control the gear being used. The vehicle control module 850 can be operated by the driver. In an auto-mode, the vehicle control module 850 can work following some specific instructions without human control. Based on the determined location of the appearance image or the indicator image in the successive image data frames from the object detecting unit 824 and location data from the distance measuring devices 840, the path generating unit 825 can generate a moving path to lead the vehicle 80 so that the power receiver 810 and a power transmitter can be overlapped by using the power receiver location data and the location of the appearance image or the indicator image. In order to have a better understanding of how the path generating unit 825 works, please refer to FIG. 11. It shows how the moving path is generated. At time T (the image of the vehicle 800 drawn on the top left), the third image capturer 803 of the vehicle 800 captures the image of a power transmitter 870 (a circle with a cross inside). Then, the successive image data frames after time T include the image of the power transmitter 870. Meanwhile, as time goes by, the image data is generated. The path generating unit 825 gets data from the distance measuring device 840 that there are two walls w sandwich the power transmitter 870. It is required to go back right and avoid colliding the walls in order to get the power receiver 810 overlapping the power transmitter 870 for charging purpose. Thus, at time T+10 (the image of the vehicle 800 drawn on the top right), the path generating unit 825 generates a moving path (represented by a bold long dashed line). The moving path is in a form of control signals sent to the vehicle control module 850. The vehicle control module 850 can follow the control signals to move the vehicle 800 in the auto-mode. At time T+20 (the image of the vehicle 800 drawn on the bottom), the vehicle 800 moves to an aligned location and the power receiver 810 and the power transmitter 870 are overlapped.

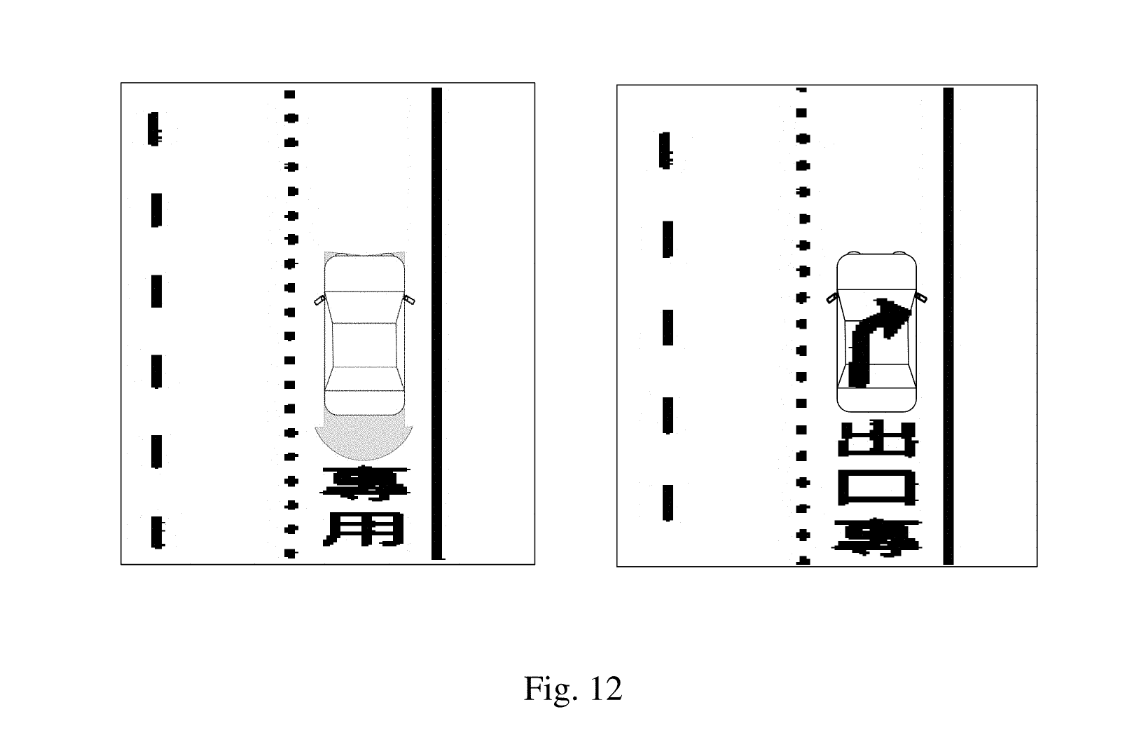

According to the present invention, the processing module 820 can further calculate a vehicle aerial view data regarding a location of a vertical projection of the vehicle 800 in the image data using a location of the four (at least one) image capturers relative to the vehicle 800. The vehicle aerial view data is basically a top view of the vehicle 800 and its size and orientation can be determined as long as the absolute location of any one of the image capturer is known (orientation can be available with an installation angle between the image capturer and a central axis of the vehicle 800). The vehicle aerial view data is used to show the image of the vehicle 800 on the display module 830. Please refer to FIG. 12. It shows two comparative graphs that are shown on the display module 830. The left graph illustrates the vehicle 800 when the vehicle image system is just initiated. The vertical projection of the vehicle 800 and two blocked zones (grey areas) cover a portion of the ground in the around view image. After the vehicle 800 moves forward for seconds, all ground scenes are clear since the image data is generated. The vehicle aerial view data is used to plot an aerial view of the vehicle 800 with sidelines to show where the vehicle 800 is to the driver (shown in the right graph). Of course, the aerial view of the vehicle 800 can be transparent, opaque or translucent as long as the effect is preferred by the driver.

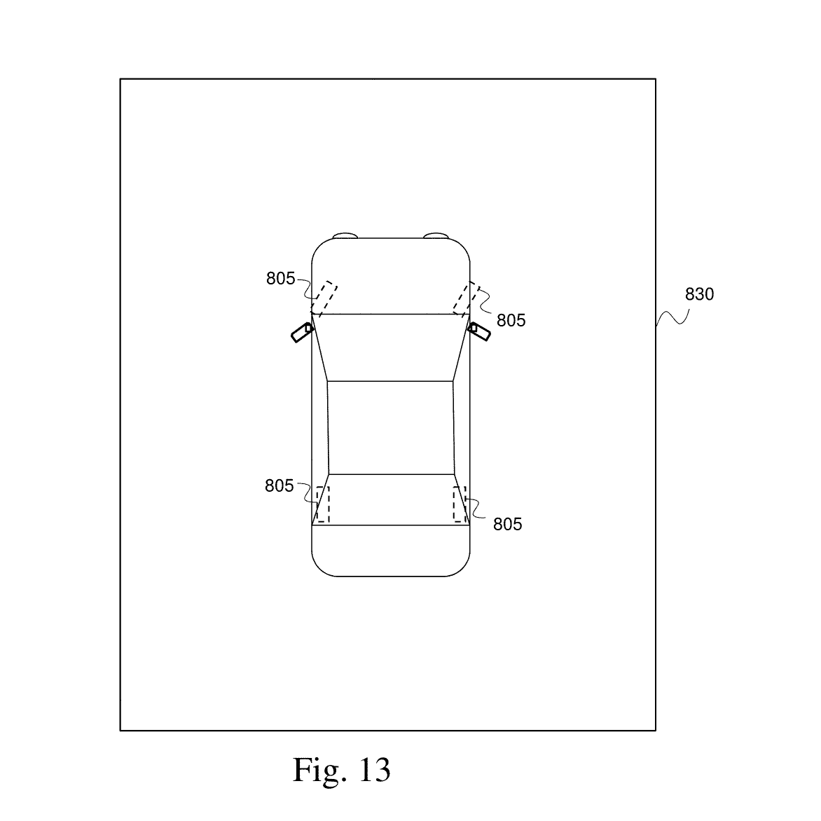

According to the present invention, the processing module 820 can further receive a vehicle steering data regarding a steering angle of at least one wheel of the vehicle 800 (e.g. from the steering controller 851 of the vehicle control module 850 or other device monitoring the steering angle). Meanwhile, the processing module 820 calculates a wheel location data of the at least one wheel in the image data by combining the vehicle aerial view data and the steering angle. The wheel location data is used to present the status (location and orientation) of the wheel(s) on the display module 830. Please see FIG. 13. 4 wheels 805 are plotted by dashed rectangles on the display module 830. The driver can easily know the front wheels are placed frontward or with an angle to the left or right. According to the present invention, the number of wheels is not limited to 4. More wheels can be shown when the vehicle 800 is equipped with more wheels. Meanwhile, the way of presenting is not limited to dashed rectangles. Colored images, various borderlines, desired shapes and even 3D effect patterns can be used.

The display module 830 is connected to the processing module 820. The display module 830 can show any information the processing module 820 sends to. In practice, the display module 830 can be an LCD, an OLED, a PLED or a Micro LED monitor. Preferably, it comes with touch-control function for interaction. The display module 830 can show at least one of the power receiver location data, the image data, the successive image data frames, the vehicle aerial view data, the wheel location data, a virtual image of the power receiver, and the appearance image or the indicator image. These data can be shown by texts and values. They can also be graphs. Even some are texts with values while others are graphs.

In the following embodiments, methods for positioning vehicles using vehicle images are disclosed. Some methods may support the operation of the vehicle image system and will be illustrated along with the operating procedure of the vehicle image system under particular mode.

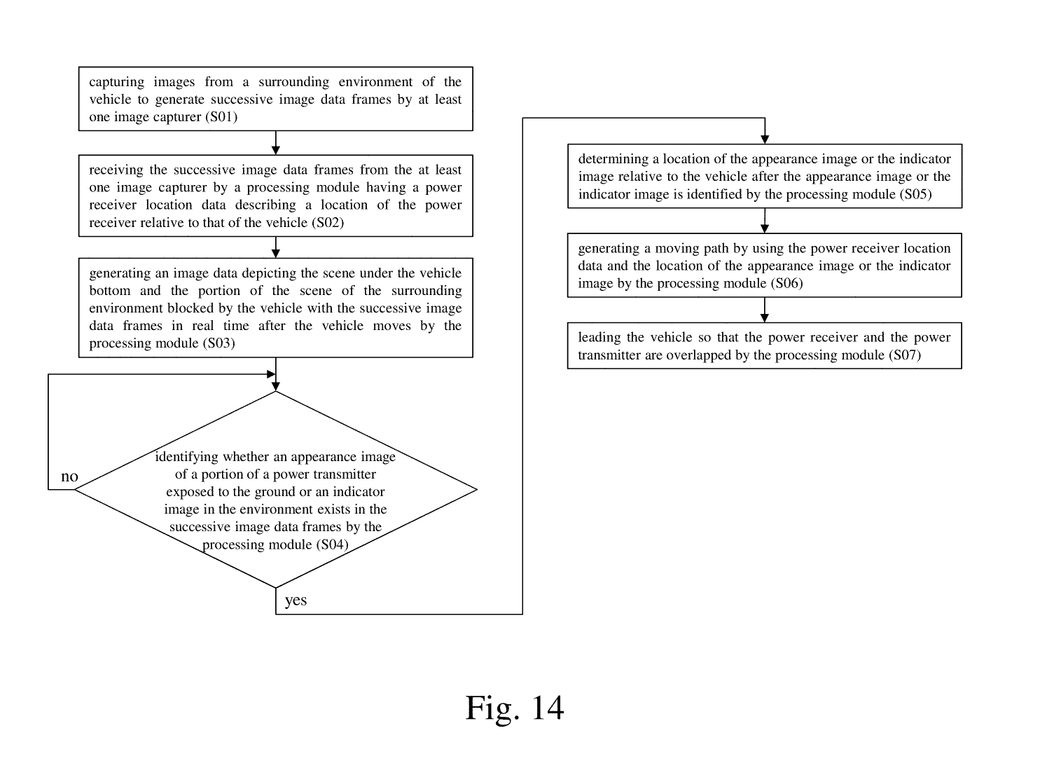

Please refer to FIG. 14. It is a flowchart of a method for positioning vehicles using vehicle images of an embodiment in the present invention. The method is suitable for a vehicle installed with at least one image capturer and a power receiver. A first step of the method is capturing images from a surrounding environment of the vehicle to generate successive image data frames by at least one image capturer (S01). As mentioned above, a view of the at least one image capturer for capturing images has a scene under the vehicle bottom and a portion of a scene of the surrounding environment blocked by the vehicle so that any one of the successive image data frames lacks the scene under the vehicle bottom or the portion of the scene of the surrounding environment. Then, a second step is receiving the successive image data frames from the at least one image capturer by a processing module having a power receiver location data describing a location of the power receiver relative to that of the vehicle (S02). Here, the processing module is a collective noun. It may include the subordinate units as mentioned above. The processing module can also be seen as a single device which provides sufficient functions to meet the requirements of the method. A third step is generating an image data depicting the scene under the vehicle bottom and the portion of the scene of the surrounding environment blocked by the vehicle with the successive image data frames in real time after the vehicle moves by the processing module (S03).

Step S01 to S03 initiate the vehicle image system to see the environment of the vehicle. Then, identify whether an appearance image of a portion of a power transmitter exposed to the ground or an indicator image in the environment exists in the successive image data frames by the processing module (S04). In this case, the appearance image or the indicator image has been preloaded to the processing module. Compared to actual operation, since the processing module of the vehicle has known the appearance image or the indicator image during the time that it was assembled for sale, when step S04 is applied, the processing module can automatically run without help from an external cloud server or an extra learning step to get the appearance image or the indicator image. If a result of step S04 is yes, meaning the appearance image or the indicator image is found in the successive image data frames, determine a location of the appearance image or the indicator image relative to the vehicle after the appearance image or the indicator image is identified by the processing module (S05). If a result of step S04 is no, meaning the appearance image or the indicator image is not found in the successive image data frames and only the scene of the environment is available currently, just repeat step S04 itself until the appearance image or the indicator image is found. Step S04 is the basic function of the processing module. After step S05 is finished, the driver can choose to use the auto-mode to move the vehicle so that the power receiver in the vehicle can overlap the power transmitter. The driver can also choose to drive the vehicle by himself in a driver-mode. In the auto-mode, the method processes the following step generating a moving path by using the power receiver location data and the location of the appearance image or the indicator image by the processing module (S06). Finally, the vehicle successfully is moved according to the moving path by a step of leading the vehicle so that the power receiver and the power transmitter are overlapped by the processing module (S07).

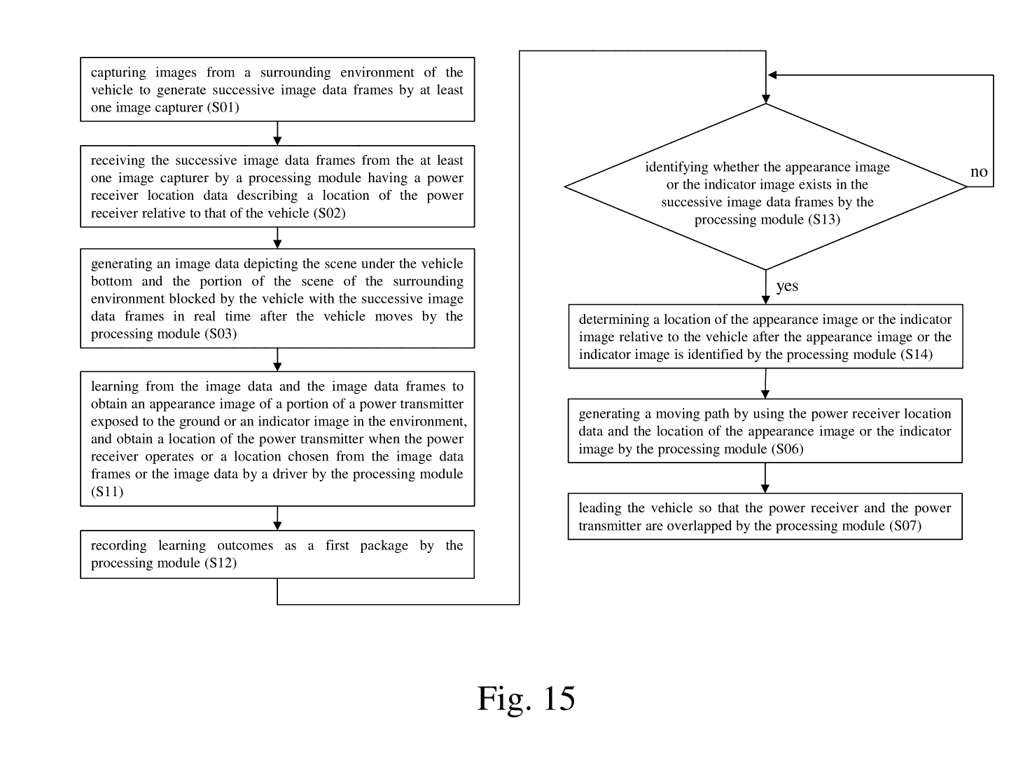

In the case that there is no appearance image or indicator image preloaded to the processing module during the time that the vehicle was assembled for sale, or new appearance image or indicator image is required for charging the vehicle in another charge system, further steps are required to process self-learning or receive the result from the cloud server. Please refer to FIG. 15. It is a flowchart of another method for positioning vehicles using vehicle images of an embodiment in the present invention. The first three steps are the same as that of the previous embodiment. They will not be repeated here. A fourth step is learning from the image data and the image data frames to obtain an appearance image of a portion of a power transmitter exposed to the ground or an indicator image in the environment, and obtain a location of the power transmitter when the power receiver operates or a location chosen from the image data frames or the image data by a driver by the processing module (S11). As described earlier, there are a number of algorithms and open source codes which can be used for self-learning. Step S1l is only a result of applicating the algorithms and/or open source codes. However, when obtaining the location of the power transmitter, it can follow a consequence of learning. Details of learning may be that when each time the power receiver operates to charge, the processing module analyzes all scene in the image data frames and the image data and find out the common feature. The location of the power transmitter can also be determined or corrected by the driver's experience through an input instruction to point out where the power transmitter is. For example, in FIG. 11, when the processing module 820 is learning what the power transmitter 870 is from the image data and the image data frames, the driver can directly decide the circle with a cross inside to be the power transmitter 870 since he knows it. For example, the driver can simply points on the display module 830 which has a touch-control function where the circle with a cross inside is and the pattern is decided as the power transmitter 870. Thus, learning time can be reduced and the result is correct. Then, recording learning outcomes as a first package by the processing module (S12). Since the appearance image or the indicator image is determined, identify whether the appearance image or the indicator image exists in the successive image data frames by the processing module (S13). If a result of step S13 is yes, determine a location of the appearance image or the indicator image relative to the vehicle after the appearance image or the indicator image is identified by the processing module (S14). If a result of step S13 is no, just repeat step S13 until the appearance image or the indicator image is found. Similarly, step S14 can be followed by the steps S06 and S07 for auto-mode.

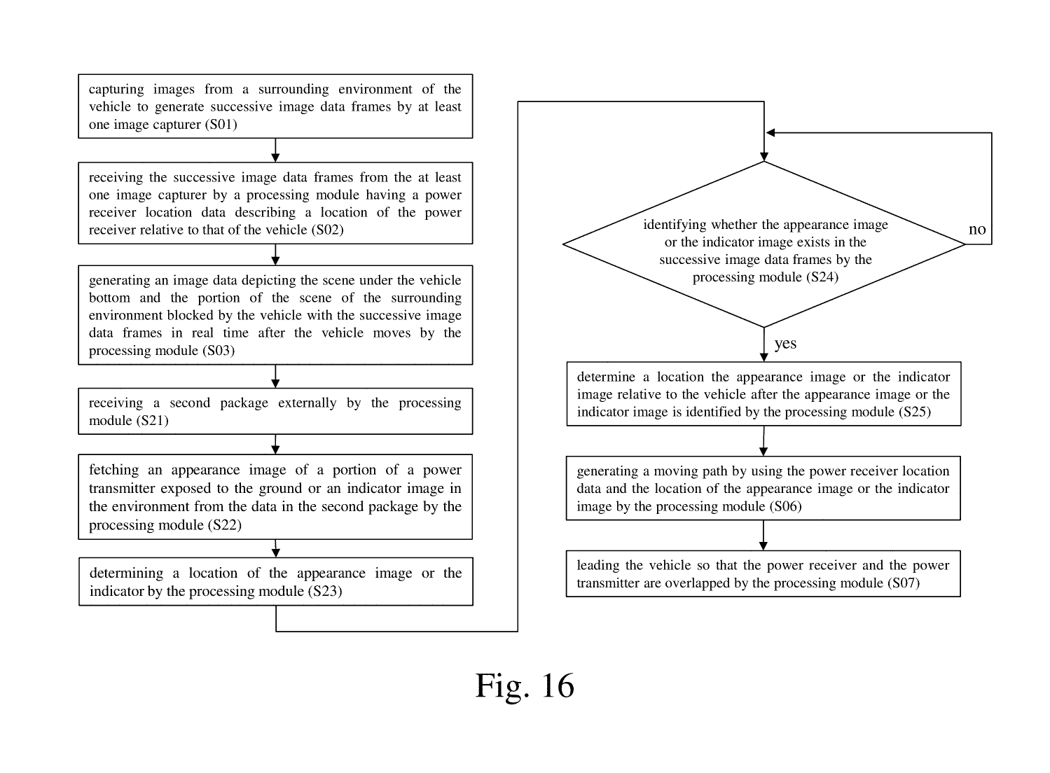

On the other hand, if the appearance image or the indicator image is not self-learned but comes from the cloud server, a modified method is required. Please see FIG. 16. It is a flowchart of another method for positioning vehicles using vehicle images of an embodiment in the present invention. The first three steps are the same as that of the previous embodiment. A fourth step is receiving a second package externally (S21). As mentioned above, the second package may be wiredly (e.g. by a RJ45 cable linked to an Ethernet interface) or wirelessly (e.g. via Bluetooth or wi-fi to an access point of a network) received. Even, the second package can be stored and transferred to the processing module by a physical device, such as a USB storage or a hard disc. Then, fetch an appearance image of a portion of a power transmitter exposed to the ground or an indicator image in the environment from the data in the second package by the processing module (S22). It means the new appearance image or indicator is already in the second package which is gained by the processing module in other vehicles or the cloud server. Next, determining a location of the appearance image or the indicator by the processing module (S23) in the image data and the image data frames. identify whether the appearance image or the indicator image exists in the successive image data frames by the processing module (S24). If a result of step S24 is yes, determine a location the appearance image or the indicator image relative to the vehicle after the appearance image or the indicator image is identified by the processing module (S25). If a result of step S24 is no, just repeat step S24 until the appearance image or the indicator image is found. Similarly, step S25 can follow by the steps S06 and S07 for auto-mode.

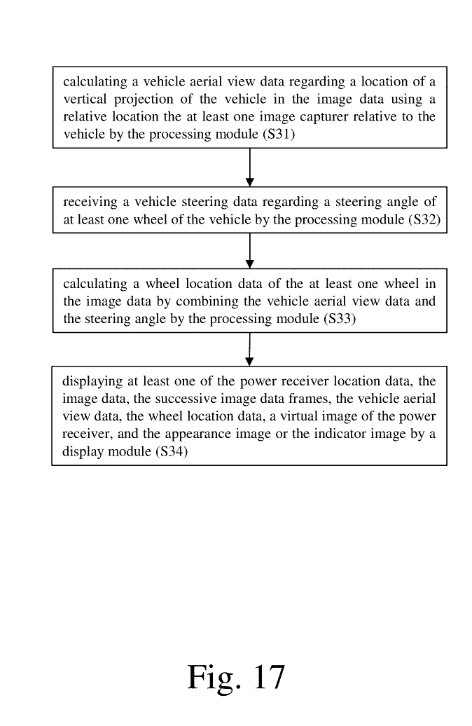

For applying to the driver-mode, a display module is necessary and some preparatory information need to be available. Please see FIG. 17. FIG. 17 is a flowchart of additional steps for preparing and displaying the preparatory information. First, calculate a vehicle aerial view data regarding a location of a vertical projection of the vehicle in the image data using a location of the at least one image capturer relative to the vehicle by the processing module (S31). The purpose of the vehicle aerial view data is provided above and not to repeat. Although it is not required by the auto-mode, the vehicle aerial view data is important to visualize the vehicle on the display module. Then, other steps can follow the step S31 are receiving a vehicle steering data regarding a steering angle of at least one wheel of the vehicle by the processing module (S32) and calculating a wheel location data of the at least one wheel in the image data by combining the vehicle aerial view data and the steering angle by the processing module (S33). Finally, display at least one of the power receiver location data, the image data, the successive image data frames, the vehicle aerial view data, the wheel location data, a virtual image of the power receiver, and the appearance image or the indicator image by a display module (S34).

There are some key points that should be emphasized. First, step S32 and S33 may not be necessary in other embodiments. Therefore, the corresponding wheel location data is not an option in step S34. Furthermore, steps S31 to S34, or steps S31 and S34, can be applied between step S03 and S07 in the flowcharts in FIG. 14 to FIG. 16. Some elements in step S34 may not be necessary. For example, if steps S031 to S34 are applied just after step S03 in each Figure, the appearance image or the indicator image will not be shown on the display module since it is available after step S04.

If the driver would like to drive by himself to charge the vehicle (driver mode), the method of the present invention can be modified to meet the goal. There are three scenarios of the driver mode: <case 1> the vehicle has no information of the power transmitter (the appearance image or the indicator image) and the driver has to drive by himself; <case 2> the vehicle identifies the power transmitter, but the driver wants to drive by himself to charge the vehicle; and <case 3> the driver drives by himself to charge the vehicle with only the help of the display module. Below are the descriptions for these cases.

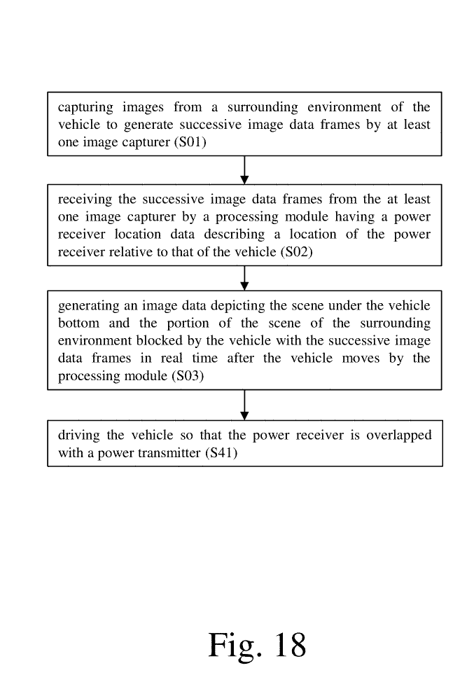

Please see FIG. 18. It is a flowchart of a method for positioning vehicles in the case 1 of the driver-mode of an embodiment in the present invention. The method has a step sequence of step S01, S02, S03 and a new step S41 of driving the vehicle so that the power receiver is overlapped with a power transmitter (S41). The processing module and the at least one image capturer are initiated and the scene under the vehicle bottom or a portion of the scene of the surrounding environment blocked by the vehicle can be available by the processing module. However, the driver doesn't use other functions of the processing module to help him drive the vehicle to charge. When the vehicle is under charge, the user may turn on the processing module again to start self-learning of the power transmitter for future use.

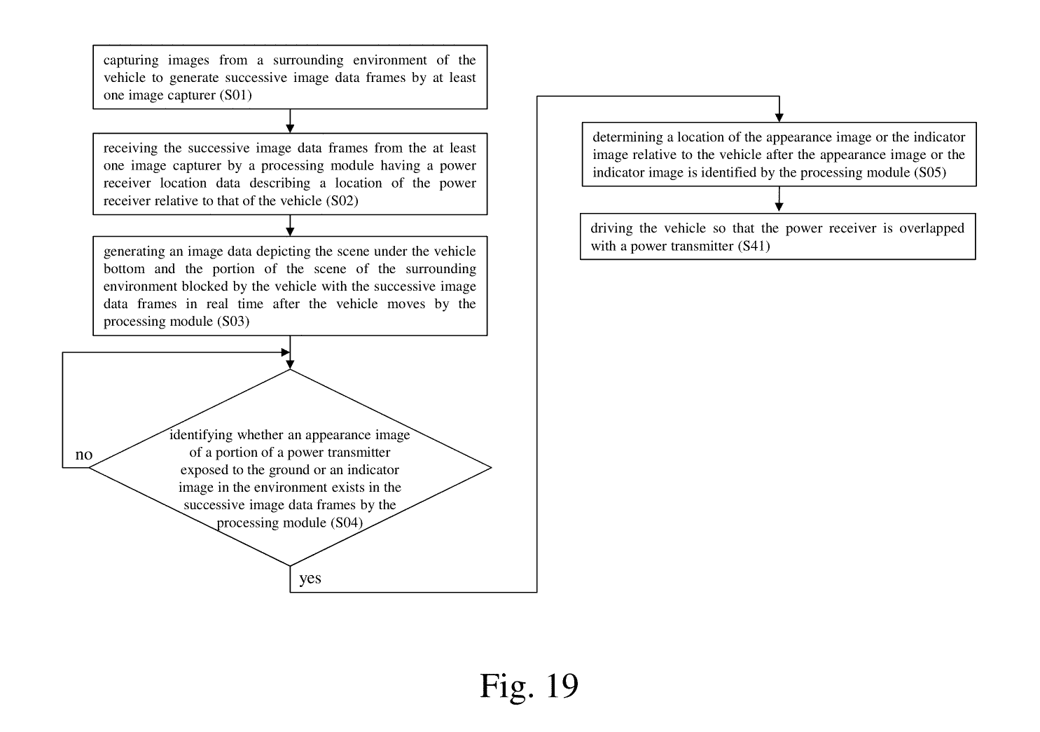

Please see FIG. 19. It is a flowchart of a method for positioning vehicles in the case 2 of the driver-mode of an embodiment in the present invention. The method has a step sequence of step S01, S02, S03, S04, S05 and S41. It means even the processing module finds the power transmitter and a moving path can be generated to lead the vehicle (step S06 and S07), he just rejects the convenient functions and drives by himself.

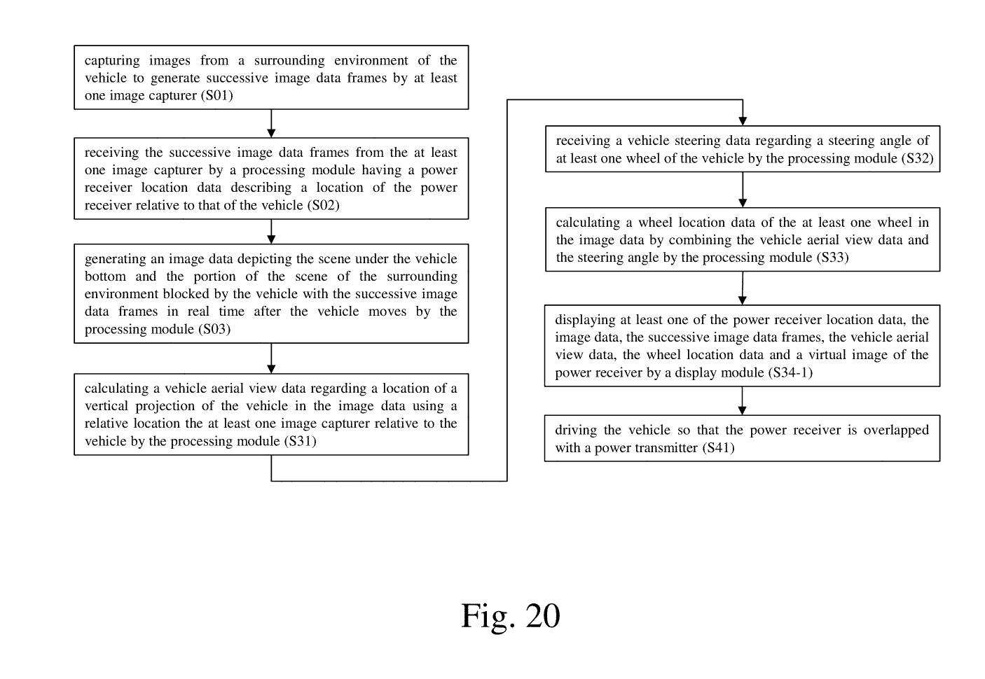

Please see FIG. 20. It is a flowchart of a method for positioning vehicles in the case 3 of the driver-mode of an embodiment in the present invention. The method has a step sequence of step S01, S02, S03, S31, S32, S33, a modified step S34-1 from step S34 that displays at least one of the power receiver location data, the image data, the successive image data frames, the vehicle aerial view data, the wheel location data and a virtual image of the power receiver by a display module and the step S41 mentioned above. It is clear that the driver can see some helpful information from the display module. However, he doesn't want to initiate the function in step S04 and S05. He has to drive by himself with the help from the display module.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A vehicle image system, installed in a vehicle which has a power receiver, comprising:
at least one image capturer, mounted to the vehicle, for capturing images from a surrounding environment of the vehicle to generate successive image data frames, wherein a view of the at least one image capturer for capturing images has a scene under the vehicle bottom or a portion of a scene of the surrounding environment blocked by the vehicle so that any one of the successive image data frames lacks the scene under the vehicle bottom or the portion of the scene of the surrounding environment; and
a processing module, connected with the at least one image capturer, having a power receiver location data describing a location of the power receiver relative to that of the vehicle, for receiving the successive image data frames from the at least one image capturer, and generating an image data depicting the scene under the vehicle bottom and the portion of the scene of the surrounding environment blocked by the vehicle with the successive image data frames in real time after the vehicle moves.

2. The vehicle image system according to claim 1, wherein the processing module further identifies whether an appearance image of a portion of a power transmitter exposed to the ground or an indicator image in the environment exists in the successive image data frames, and determines a location of the appearance image or the indicator image relative to the vehicle after the appearance image or the indicator image is identified.

3. The vehicle image system according to claim 1, wherein the processing module further comprises:
a memory unit, for storing the successive image data frames and the image data; and
a learning unit, operated to execute one of following functions:
learning from the image data and the image data frames to obtain an appearance image of a portion of a power transmitter exposed to the ground or an indicator image in the environment, and obtain a location of the power transmitter when the power receiver operates or a location chosen from the image data frames or the image data by a driver, and recording learning outcomes as a first package; and
receiving a second package externally and fetching an appearance image or an indicator image therein.

4. The vehicle image system according to claim 3, wherein the learning unit is a portion of hardware in the processing module, or software operated in the processing module.

5. The vehicle image system according to claim 2, wherein the processing module further comprises an object detecting unit for determining a location of the appearance image or the indicator image in the successive image data frames.

6. The vehicle image system according to claim 2, wherein the processing module further comprises a path generating unit for generating a moving path to lead the vehicle so that the power receiver and the power transmitter are overlapped by using the power receiver location data and the location of the appearance image or the indicator image.

7. The vehicle image system according to claim 2, wherein the processing module further calculates a vehicle aerial view data regarding a location of a vertical projection of the vehicle in the image data using a location of the at least one image capturer relative to the vehicle.

8. The vehicle image system according to claim 7, wherein the processing module further receives a vehicle steering data regarding a steering angle of at least one wheel of the vehicle and calculates a wheel location data of the at least one wheel in the image data by combining the vehicle aerial view data and the steering angle.

9. The vehicle image system according to claim 1, further comprising a display module, connected with the processing module, for displaying at least one of the power receiver location data, the image data, the successive image data frames and a virtual image of the power receiver.

10. The vehicle image system according to claim 2, further comprising a display module, connected with the processing module, for displaying at least one of the power receiver location data, the image data, the successive image data frames, a virtual image of the power receiver, and the appearance image or the indicator image.

11. The vehicle image system according to claim 7, further comprising a display module, connected with the processing module, for displaying at least one of the power receiver location data, the image data, the successive image data frames, the vehicle aerial view data, a virtual image of the power receiver, and the appearance image or the indicator image.

12. The vehicle image system according to claim 8, further comprising a display module, connected with the processing module, for displaying at least one of the power receiver location data, the image data, the successive image data frames, the vehicle aerial view data, the wheel location data, a virtual image of the power receiver, and the appearance image or the indicator image.

13. A method for positioning vehicles using vehicle images, suitable for a vehicle installed with at least one image capturer and a power receiver, comprising:
capturing images from a surrounding environment of the vehicle to generate successive image data frames by at least one image capturer, wherein a view of the at least one image capturer for capturing images has a scene under the vehicle bottom and a portion of a scene of the surrounding environment blocked by the vehicle so that any one of the successive image data frames lacks the scene under the vehicle bottom or the portion of the scene of the surrounding environment;
receiving the successive image data frames from the at least one image capturer by a processing module having a power receiver location data describing a location of the power receiver relative to that of the vehicle; and
generating an image data depicting the scene under the vehicle bottom and the portion of the scene of the surrounding environment blocked by the vehicle with the successive image data frames in real time after the vehicle moves by the processing module.

14. The method for positioning vehicles according to claim 13, further comprising:
identifying whether an appearance image of a portion of a power transmitter exposed to the ground or an indicator image in the environment exists in the successive image data frames by the processing module; and
determining a location of the appearance image or the indicator image relative to the vehicle after the appearance image or the indicator image is identified by the processing module.

15. The method for positioning vehicles according to claim 13, further comprising:
learning from the image data and the image data frames to obtain an appearance image of a portion of a power transmitter exposed to the ground or an indicator image in the environment, and obtain a location of the power transmitter when the power receiver operates or a location chosen from the image data frames or the image data by a driver by the processing module;
recording learning outcomes as a first package by the processing module;
identifying whether the appearance image or the indicator image exists in the successive image data frames by the processing module; and
determining a location of the appearance image or the indicator image relative to the vehicle after the appearance image or the indicator image is identified by the processing module.

16. The method for positioning vehicles according to claim 13, further comprising:
receiving a second package externally by the processing module;
fetching an appearance image of a portion of a power transmitter exposed to the ground or an indicator image in the environment from the data in the second package by the processing module;
determining a location of the appearance image or the indicator by the processing module;
identifying whether the appearance image or the indicator image exists in the successive image data frames by the processing module; and
determining a location the appearance image or the indicator image relative to the vehicle after the appearance image or the indicator image is identified by the processing module.

17. The method for positioning vehicles according to claim 14, further comprising:
generating a moving path by using the power receiver location data and the location of the appearance image or the indicator image by the processing module; and
leading the vehicle so that the power receiver and the power transmitter are overlapped by the processing module.

18. The method for positioning vehicles according to claim 13, further comprising:
calculating a vehicle aerial view data regarding a location of a vertical projection of the vehicle in the image data using a location of the at least one image capturer relative to the vehicle by the processing module.

19. The method for positioning vehicles according to claim 18, further comprising:
receiving a vehicle steering data regarding a steering angle of at least one wheel of the vehicle by the processing module; and
calculating a wheel location data of the at least one wheel in the image data by combining the vehicle aerial view data and the steering angle by the processing module.

20. The method for positioning vehicles according to claim 13, further comprising:
displaying at least one of the power receiver location data, the image data, the successive image data frames and a virtual image of the power receiver by a display module.

21. The method for positioning vehicles according to claim 14, further comprising:
displaying at least one of the power receiver location data, the image data, the successive image data frames, a virtual image of the power receiver, and the appearance image or the indicator image by a display module.

22. The method for positioning vehicles according to claim 18, further comprising:
displaying at least one of the power receiver location data, the image data, the successive image data frames, the vehicle aerial view data and a virtual image of the power receiver by a display module.

23. The method for positioning vehicles according to claim 19, further comprising:
displaying at least one of the power receiver location data, the image data, the successive image data frames, the vehicle aerial view data, the wheel location data and a virtual image of the power receiver.
